(19) United States
(12) Patent Application Publication
(10) Pub. No.: US 2009/0212721 A1
(43) Pub. Date: Aug. 27, 2009

(54) LED DRIVE CIRCUIT

(76) Inventor: Yasuhiro MARUYAMA, Katsuragi-shi (JP)

Correspondence Address: BIRCH STEWART KOLASCH & BIRCH, PO BOX 747, FALLS CHURCH, VA, 22040-0747, US

(21) Appl. No.: 12/390,206

(22) Filed: Feb. 20, 2009

(30) Foreign Application Priority Data
Feb. 21, 2008 (JP) 2008-040440

(51) Int. Cl. H05B 37/02

(52) U.S. Cl. 315/307

(57) ABSTRACT

An LED drive circuit includes a constant-current circuit that supplies a constant-current to an LED module to drive it; a thyristor; and a phase-angle control circuit which adjusts the ignition angle of the thyristor. The LED module, the constant-current circuit, and the thyristor are connected in series.

This nonprovisional application claims priority under 35 U.S.C. §119(a) on Patent Application No. 2008-40440 filed in Japan on Feb. 21, 2008, the entire contents of which are hereby incorporated by reference.

### BACKGROUND OF THE INVENTION

1. Field of the Invention

The present invention relates to an LED drive circuit that drives an LED (light emitting diode).

2. Description of Related Art

LEDs offer advantages such as low current consumption and long-life, and have been finding an increasingly wide range of application, not only in display devices but also in lighting apparatuses, etc. In an LED lighting apparatus, typically a plurality of LEDs are used to attain desired illuminance.

Since the lives of the LEDs are shortened when a current beyond the rated current is passed through them, they need to be driven with a constant current, or with current limiting applied such that no current equal to or larger than a predetermined current passes through them.

Common lighting apparatuses typically use commercial power supply of AC 100 V; considering cases where LED lighting apparatuses are used in place of incandescent lamps, it is preferable that LED lighting apparatuses, like common lighting apparatuses, be so configured as to use commercial power supply of AC 100 V.

Here, one example (see FIG. 3 of JP-A-2003-59335) of the configuration of a conventional LED drive circuit that can be used in an LED lighting apparatus is shown in FIG. 4. The conventional LED drive circuit shown in FIG. 4 is an LED drive circuit that applies current limiting such that no current equal to or larger than a predetermined current passes through LEDs, and is composed of a bridge diode 2, resistors R1 to R3, a phase-angle control circuit A11, a trigger device 5 such as an SBS (silicon bilateral switch) or a diac (short for diode alternating-current switch, also called bidirectional diode thyristor), and a thyristor 4.

To the input side of the bridge diode 2, a commercial power supply 1 of AC 100 V is connected; to the output side of the bridge diode 2 are connected the resistor R3, an LED module 3—which is a plurality of LEDs connected in series—, and the thyristor 4 in the following order from the positive output terminal of the bridge diode 2: the resistor R3, the LED module 3, and the thyristor 4. One end of the resistor R2 is connected to the node between the resistor R3 and the LED module 3, and the other end of the resistor R2 is connected to the node between the LED module 3 and the anode of the thyristor 4.

The phase-angle control circuit A11 is provided with: a resistor R11, of which one end is connected to the other end of the resistor R2; a variable resistor VR11, of which one end is connected to the other end of the resistor R11 and of which the other end is connected to one end of a capacitor C11 and to the gate of the thyristor 4 via the trigger device 5; and the capacitor C11, of which the other end is connected to the gate of the thyristor 4 via the resistor R1 and to the cathode of the thyristor 4.

With this configuration, the AC voltage outputted from the commercial power supply 1 of AC 100 V is full-wave-rectified by the bridge diode 2, and a pulsating voltage with a peak value of about 141 V is obtained. In the phase-angle control circuit A11, by adjusting the resistance of the variable resistor VR11, it is possible to adjust the ignition angle of the thyristor 4. Thus, it is possible to adjust the on-period of the thyristor 4, thereby to supply the pulsating voltage to the LED module 3 within the adjusted on-period, and thereby to adjust illumination.

Note that in the conventional LED drive circuit shown in FIG. 4, current limiting is applied with the resistor R3 such that no current equal to or larger than a predetermined current passes through the LED module 3.

Next, another example (see FIG. 1 of JP-A-2000-260578) of the configuration of a conventional LED drive circuit that can be used in an LED lighting apparatus is shown in FIG. 5. The conventional LED drive circuit shown in FIG. 5 is an LED drive circuit that drives LEDs with a constant current, and is composed of a bridge diode 2, a resistor R5, and a constant-current circuit B11. The constant-current circuit B11 is composed of an NPN transistor Q1, a resistor R4, and a Zener diode ZD11.

To the input side of the bridge diode 2, a commercial power supply 1 of AC 100 V is connected; to the output side of the bridge diode 2 are connected an LED module 3—which is a plurality of LEDs connected in series—, the NPN transistor Q1, and the resistor R4 in the following order from the positive output terminal of the bridge diode 2: the LED module 3, the NPN transistor Q1, and the resistor R4. One end of the resistor R5 is connected to the node between the bridge diode 2 and the LED module 3; the other end of the resistor R5 and the cathode of the Zener diode ZD11 are connected to the base of the NPN transistor Q1; and the anode of the Zener diode ZD11 is connected to the node between the resistor R4 and the bridge diode 2.

With this configuration, the AC voltage outputted from the commercial power supply 1 of AC 100 V is full-wave rectified by the bridge diode 2, and a pulsating voltage with a peak value of about 141 V is obtained. In the constant-current circuit B11, since the base potential of the NPN transistor Q1 is clamped at the Zener voltage V_{Z} of the Zener diode ZD11 and is constant, when the base-emitter voltage of the NPN transistor Q1 is V_{BEQ1}, the voltage across the resistor R4 is (V_{Z}-V_{BEQ1}), and when the resistance of the resistor R4 is R₄, the current through the resistor R4 is constant at (V_{Z}-V_{BEQ1})/R₄. That is, the current which passes through the LED module 3 is constant at (V_{Z}-V_{BEQ1})/R₄.

Although the conventional LED drive circuit shown in FIG. 4 can adjust illumination by phase-angle control of the thyristor 4, since current limiting is performed with the resistor R3, when the AC voltage outputted from the commercial power supply 1 of AC 100 V varies, the current passing through the LED module 3 varies accordingly, and thus the brightness varies. In addition, in the conventional LED drive circuit shown in FIG. 4, if the number of stages of series connection in the LED module 3 is changed with the resistance of the resistor R3—which performs current limiting—unchanged, the value of the current passing through the LED module 3 greatly varies.

Although the conventional LED drive circuit shown in FIG. 5 cannot adjust illumination, the LED module 3 is driven with a constant current within the range permitted by the withstand voltage of the NPN transistor Q1, even in a case where the AC voltage outputted from the commercial power supply 1 of AC 100 V varies, or where the number of stages of series connection in the LED module 3 is changed. In addition, let the forward voltage per LED be V_{F} and the number of stages of series connection in the LED module 3 be N, then, through the LED module 3, a current starts to pass when the peak value of the AC voltage outputted from the commercial power supply 1 of AC 100 V exceeds V_{F}×N, and no current passes when it is below V_{F}×N. When the peak value of the AC voltage outputted from the commercial power supply 1 of AC 100 V is below V_{F}×N, since no current passes through the LED module 3, if the peak value of the AC voltage outputted from the commercial power supply 1 of AC 100 V exceeds the Zener voltage V_{Z} of the Zener diode ZD1, a current passes along the path from the bridge diode 2 to the resistor R5 then to the base of the NPN transistor Q1 then to the emitter of the NPN transistor Q1 and then to the resistor R4; thus the constant-current circuit B11 tends to produce a constant current by use of the current which passes from the base to the emitter of the NPN transistor Q1. Moreover, generally, the temperature response of the voltage of a Zener diode is positive (as temperature increases, the voltage rises), the temperature response of the base-emitter voltage of a transistor is negative (as temperature increases, the voltage drops), and the temperature response of a resistor is positive (as temperature increases, the resistance increases); thus the temperature response of the constant-current circuit B11 is positive (as temperature increases, the constant-current value increases). Thus, in the conventional LED drive circuit shown in FIG. 5, a rise in temperature may cause a current equal to or larger than a predetermined current to pass through the LEDs.

### SUMMARY OF THE INVENTION

An object of the present invention is to provide an LED drive circuit that can adjust illumination, that can prevent a current equal to or larger than a predetermined current from passing through LEDs even if the supplied voltage varies, and that operates with enhanced efficiency.

To achieve the above object, an LED drive circuit according to the present invention is provided with: a constant-current circuit that supplies a constant current to an LED to drive it; a thyristor, triac, photothyristor, or phototriac; and a phase-angle control circuit that adjusts the ignition angle of the thyristor, triac, photothyristor, or phototriac. Here, the LED, the constant-current circuit, and the thyristor, triac, photothyristor, or phototriac are connected in series.

With this configuration, the phase-angle control circuit adjusts the ignition angle of the thyristor, triac, photothyristor, or phototriac; it is thus possible to adjust the illumination of the LED. Moreover, with this configuration, the constant-current circuit supplies a constant current to the LED to drive it, and thus the peak value of the current which passes through the LED does not exceed the value set by the constant-current circuit. This makes it possible to prevent a current equal to or larger than a predetermined current from passing through the LED even in a case where the voltage of a power supply varies, or where the number of stages is changed in a configuration in which a plurality of LEDs are connected in series.

FIGS. 6A, 6B, 7A, and 7B show a comparison between an LED current waveform obtained with a conventional limiting resistor and that obtained with a constant-current circuit according to the present invention. As will be clear from what is shown there, compared with current limiting achieved with a limiting resistor, that achieved with a constant-current circuit involves lower power consumption by other than an LED (i.e., by the current-limiting circuit); in particular, in cases where, as shown in FIGS. 7A and 7B, when illumination is controlled to be dim, there is almost no power consumption by other than an LED. Thus, by employing an LED drive circuit where current limiting is performed with a constant-current circuit, it is possible to provide a light control circuit with enhanced efficiency.

The constant-current circuit may be composed solely of one or more transistors and resistors. Moreover, the transistor may be a bipolar transistor.

The phase-angle control circuit may have a capacitor and resistor, thereby to adjust the ignition angle of the thyristor, triac, photothyristor, or phototriac to an angle corresponding to the time constant determined by the resistance of the resistor and the capacitance of the capacitor.

To the series-connection circuit of the LED, the constant-current circuit, and the thyristor, triac, photothyristor, or phototriac, a voltage based on an AC power supply voltage may be applied; the phase-angle control circuit may detect the zero-cross point of the AC power supply voltage, and ignite the thyristor, triac, photothyristor, or phototriac a predetermined time after the zero-cross point of the AC power supply voltage; the predetermined time may be variable.

### BRIEF DESCRIPTION OF THE DRAWINGS

FIG. 1 is a diagram showing an example of the configuration of an LED drive circuit according to the present invention.

FIG. 2 is a diagram showing another example of the configuration of an LED drive circuit according to the present invention.

FIG. 3 is a diagram showing still another example of the configuration of an LED drive circuit according to the present invention.

FIG. 4 is a diagram showing an example of the configuration of a conventional LED drive circuit.

FIG. 5 is a diagram showing another example of the configuration of a conventional LED drive circuit.

FIG. 6A is a diagram showing the current and voltage waveforms observed at relevant points in a conventional LED drive circuit when illumination is controlled to be relatively bright.

FIG. 6B is a diagram showing the current and voltage waveforms observed at relevant points in an LED drive circuit according to the invention when illumination is controlled to be relatively bright.

FIG. 7A is a diagram showing the current and voltage waveforms observed at relevant points in a conventional LED drive circuit when illumination is controlled to be dim (such as for all-night illumination).

FIG. 7B is a diagram showing the current and voltage waveforms observed at relevant points in an LED drive circuit according to the invention when illumination is controlled to be dim (such as for all-night illumination).

FIGS. 8A and 8B are diagrams showing embodiments where other constant-current circuits are used in LED drive circuits according to the invention.

### DETAILED DESCRIPTION OF PREFERRED EMBODIMENTS

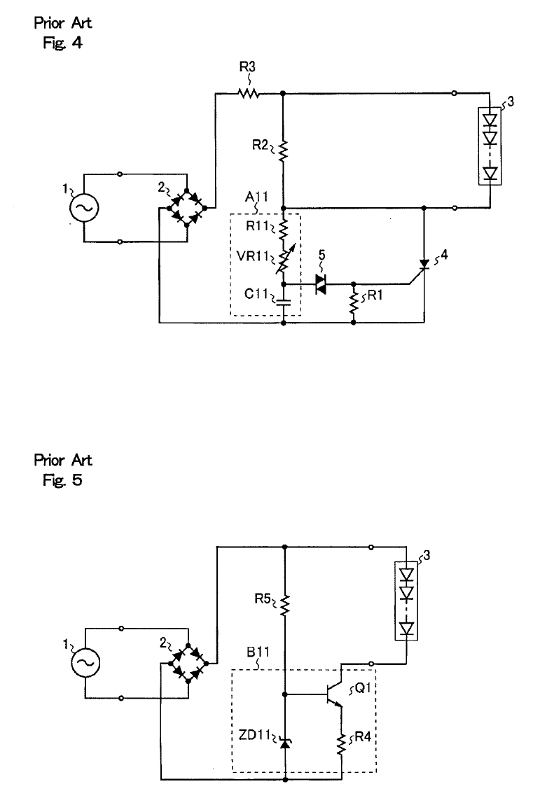

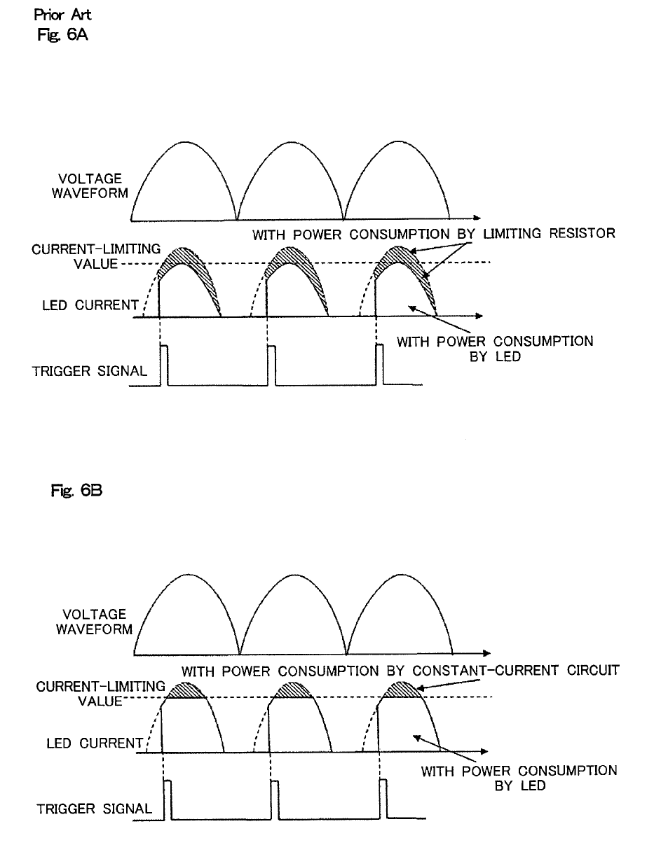

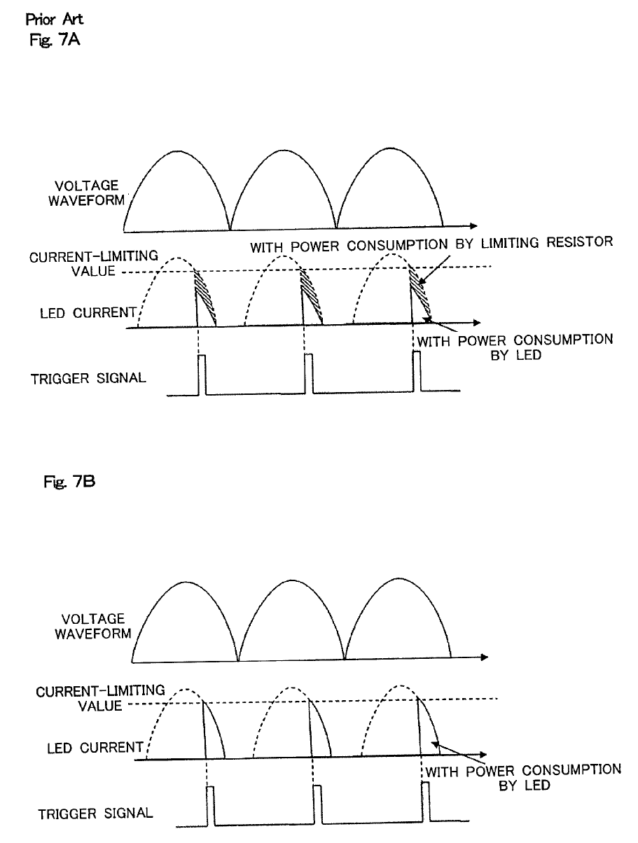

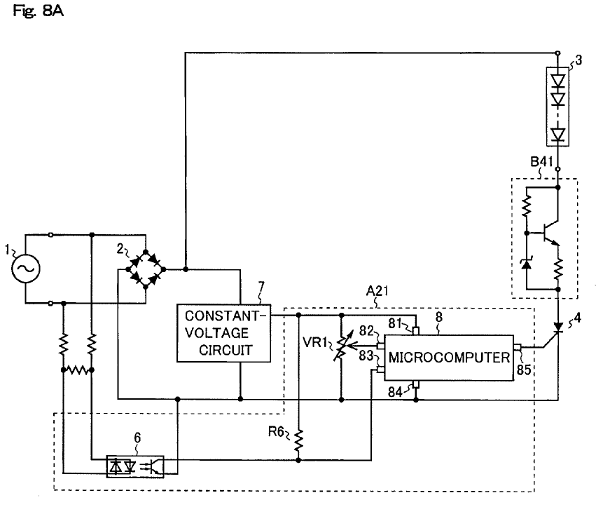

Embodiments of an LED drive circuit according to the present invention will be described below with reference to the accompanying drawings. One example of the configuration of an LED drive circuit according to the invention is shown in FIG. 1. Such parts shown in FIG. 1 as find their counterparts in FIG. 4 are identified by common reference signs, and no detailed description of them will be repeated.

Compared with the conventional LED drive circuit shown in FIG. 4, the LED device circuit according to the invention shown in FIG. 1 differs in that the resistor R3 provided in the former is removed, and in that a constant-current circuit B21 is additionally provided between the LED module 3 and the anode of the thyristor 4.

The constant-current circuit B21 is composed of resistors R21 and R22, and NPN transistors Q21 and Q22. One end of the resistor R21 and the collector of the NPN transistor Q21 are connected to the LED module 3, one end of the resistor R22 and the emitter of the NPN transistor Q22 are connected to the anode of the thyristor 4, the other end of the resistor R21 is connected to the base of the NPN transistor Q21 and to the collector of the NPN transistor Q22, and the other end of the resistor R22 is connected to the emitter of the NPN transistor Q21 and to the base of the NPN transistor Q22.

With this configuration, the AC voltage outputted from the commercial power supply 1 of AC 100 V is full-wave-rectified by the bridge diode 2, and a pulsating voltage with a peak value of about 141 V is obtained. In the phase-angle control circuit A11, by adjusting the resistance of the variable resistor VR11, it is possible to vary the time constant determined by the resistance of the resistor R11, the resistance of the variable resistor VR11, and the capacitance of the capacitor C11, and thereby adjust the ignition angle of the thyristor 4. Thus, it is possible to adjust the on-period of the thyristor 4, thereby to supply the pulsating voltage to the LED module 3 within the adjusted on-period, and thereby to adjust illumination.

In the constant-current circuit B21, since the base-emitter voltage V_{BEQ22} of the NPN transistor Q22 is applied across the resistor R22 provided between the base and emitter of the NPN transistor Q22, a constant current V_{BEQ22}/R₂₂ passes through the resistor R22 with the resistance R₂₂, and this constant current is the emitter current I_{EQ21} of the NPN transistor Q21. When the base current of the NPN transistor Q21 is ignored, the LED module 3 is driven by this emitter current I_{EQ21}.

The pulsating voltage with a peak value of about 141 V described above is applied to a series circuit of the LED module 3, the constant-current circuit B21, and the thyristor 4; thus, let the forward voltage per LED be V_{F} and the number of stages of series connection in the LED module 3 be N, then, through the LED module 3, a current starts to pass when the peak value of the AC voltage outputted from the commercial power supply 1 of AC 100 V exceeds V_{F}×N, and no current passes when it is below V_{F}×N; accordingly the current that passes through the LED module 3 is a pulsating current, but the peak value of the current that passes through the LED module 3 does not exceed the value (V_{BEQ22}/R₂₂) set by the constant-current circuit B21. This makes it possible, even when the AC voltage outputted from the commercial power supply 1 of AC 100 V varies or when the number of stages of series connection in the LED module 3 is changed, to prevent a current equal to or larger than a predetermined current from passing through the LED module 3. Having the resistor R22 inserted between the base and emitter of the NPN transistor Q22, the constant-current circuit B21 has a negative temperature response (as temperature increases, the constant-current value decreases). Thus, in the LED drive circuit according to the invention shown in FIG. 1, even temperature increases, no current equal to or larger than a predetermined current passes through the LED module 3.

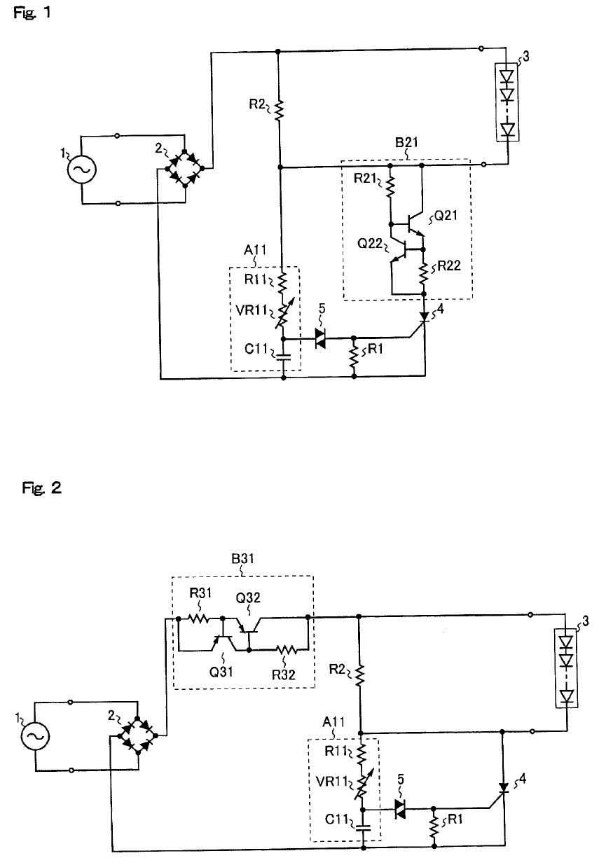

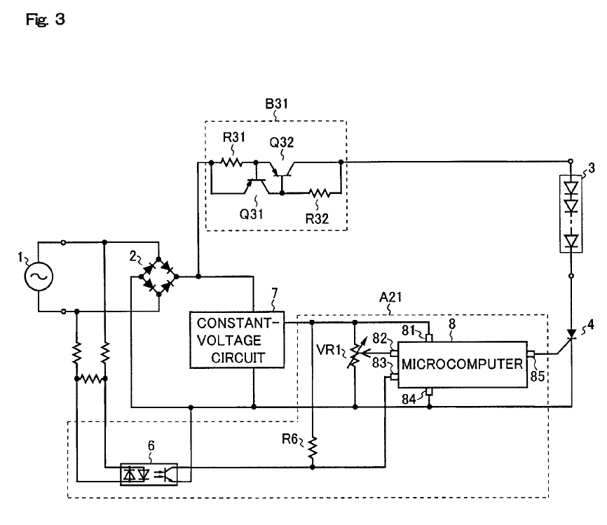

Next, another example of the configuration of an LED drive circuit according to the invention is shown in FIG. 2. Such parts shown in FIG. 2 as find their counterparts in FIG. 4 are identified by common reference signs, and no detailed description of them will be repeated.

Compared with the conventional LED drive circuit shown in FIG. 4, the LED drive circuit according to the invention shown in FIG. 2 differs in that the resistor R3 provided in the former is removed, and in that a constant-current circuit B31, instead of the removed resistor R3, is additionally provided.

The constant-current circuit B31 is composed of resistors R31 and R32, and PNP transistors Q31 and Q32. One end of the resistor R31 and the emitter of the PNP transistor Q31 are connected to the positive output terminal of a bridge diode 2, one end of the resistor R32 and the collector of the PNP transistor Q32 are connected to the node between an LED module 3 and a resistor R2, the other end of the resistor R31 is connected to the base of the PNP transistor Q31 and to the emitter of the PNP transistor Q32, and the other end of the resistor R32 is connected to the collector of the PNP transistor Q31 and to the base of the PNP transistor Q32.

With this configuration, the AC voltage outputted from the commercial power supply 1 of AC 100 V is full-wave-rectified by the bridge diode 2, and a pulsating voltage with a peak value of about 141 V is obtained. In the phase-angle control circuit A11, by adjusting the resistance of the variable resistor VR11, it is possible to vary the time constant determined by the resistance of the resistor R11, the resistance of the variable resistor VR11, and the capacitance of the capacitor C11, and thereby adjust the ignition angle of the thyristor 4. Thus, it is possible to adjust the on-period of the thyristor 4, thereby to supply the pulsating voltage to the LED module 3 within the adjusted on-period, and thereby to adjust illumination.

In the constant-current circuit B31, since the base-emitter voltage V_{BEQ31} of the PNP transistor Q31 is applied across the resistor R31 provided between the base and emitter of the PNP transistor Q31, a constant current V_{BEQ31}/R₃₁ passes through the resistor R31 with the resistance R₃₁, and this constant current is the emitter current I_{EQ32} of the PNP transistor Q32. When the base current of the PNP transistor Q32 is ignored, the LED module 3 is driven by this emitter current I_{EQ32}.

The pulsating voltage with a peak value of about 141 V described above is applied to a series circuit of the constant-current circuit B31, the LED module 3, and the thyristor 4; thus, let the forward voltage per LED be V_{F} and the number of stages of series connection in the LED module 3 be N, then, through the LED module 3, a current starts to pass when the peak value of the AC voltage outputted from the commercial power supply 1 of AC 100 V exceeds V_{F}×N, and no current passes when it is below V_{F}×N; accordingly the current that passes through the LED module 3 is a pulsating current, but the peak value of the current that passes through the LED module 3 does not exceed the value (V_{BEQ31}/R₃₁) set by the constant-current circuit B31. This makes it possible, even when the AC voltage outputted from the commercial power supply 1 of AC 100 V varies or when the number of stages of series connection in the LED module 3 is changed, to prevent a current equal to or larger than a predetermined current from passing through the LED module 3. Having the resistor R31 inserted between the base and emitter of the PNP transistor Q31, the constant-current circuit B31 has a negative temperature response (as temperature increases, the constant-current value decreases). Thus, in the LED drive circuit according to the invention shown in FIG. 2, even temperature increases, no current equal to or larger than a predetermined current passes through the LED module 3.

Next, still another example of the configuration of an LED drive circuit according to the invention is shown in FIG. 3. Such parts shown in FIG. 3 as find their counterparts in FIG. 2 are identified by common reference signs, and no detailed description of them will be repeated.

Compared with the LED drive circuit according to the invention shown in FIG. 2, the LED drive circuit shown in FIG. 3 differs in that the resistor R2, the phase-angle control circuit A11, the trigger device 5, and the resistor R1 provided in the former are removed, and in that a constant-voltage circuit 7, a phase-angle control circuit A21, and a resistor connected between the phase-angle control circuit A21 and a commercial power supply 1 of AC 100 V are additionally provided.

To the output side of the bridge diode 2 are a constant-current circuit B31, an LED module 3, and a thyristor 4 connected in series in the following order from the positive output terminal of the bridge diode 2: the constant-current circuit B31, the LED module 3, and the thyristor 4.

The input terminal of the constant-voltage circuit 7 is connected to the positive output terminal of the bridge diode 2, the ground terminal of the constant-voltage circuit 7 is connected to the negative output terminal of the bridge diode 2 and to a port 84 of a microcomputer 8, and the output terminal of the constant-voltage circuit 7 is connected to a port 81 of the microcomputer 8.

The phase-angle control circuit A21 is composed of a photocoupler 6, the microcomputer 8, a resistor R6, and a variable resistor VR1. The photocoupler 6 is composed of two LEDs, connected in opposite directions and serving as a light-emitting portion, and a phototransistor, serving as a light-receiving portion. The two LEDs, connected in opposite directions and serving as the light-emitting portion of the photocoupler 6, are connected to the commercial power supply 1 of AC 100 V via the resistor. The emitter of the phototransistor, serving as the light-receiving portion of the photocoupler 6, is connected to the ground terminal of the constant-voltage circuit 7, and the collector of the phototransistor, serving as the light-receiving portion of the photocoupler 6, is connected to a port 83 of the microcomputer 8, and to the output terminal of the constant-voltage circuit 7 via the resistor R6. A port 82 of the microcomputer 8 is the port at which the microcomputer 8 reads the voltage of the variable resistor VR1 inserted between the output terminal and ground terminal of the constant-voltage circuit 7; a port 85 of the microcomputer 8 is connected to the gate of the thyristor 4.

With this configuration, the AC voltage outputted from the commercial power supply 1 of AC 100 V is full-wave-rectified by the bridge diode 2, and a pulsating voltage with a peak value of about 141 V is obtained. In the constant-voltage circuit 7, the pulsating voltage inputted between the input terminal and ground terminal is converted into a constant voltage, and the constant voltage is outputted as the output terminal-ground terminal voltage. The microcomputer 8 is driven with the constant voltage that is outputted from the constant-voltage circuit 7 and is applied between the ports 81 and 84. The microcomputer 8 detects the zero-cross point of the AC voltage outputted from the commercial power supply 1 of AC 100 V based on the output signal of the photocoupler 6 inputted into the port 83, reads the voltage of the variable resistor VR1 from the port 82, and outputs the pulse signal from the port 85 a predetermined time (a time corresponding to the voltage of the variable resistor VR1) after the zero-cross point of the AC voltage outputted from the commercial power supply 1 of AC 100 V to feed it to the gate of the thyristor 4. Accordingly, by adjusting the resistance of the variable resistor VR1, it is possible to adjust the ignition angle of the thyristor 4. Thus, it is possible to adjust the on-period of the thyristor 4, thereby to supply the pulsating voltage to the LED module 3 within the adjusted on-period, and thereby to adjust illumination.

In the constant-current circuit B31, since the base-emitter voltage V_{BEQ31} of the PNP transistor Q31 is applied across the resistor R31 provided between the base and emitter of the PNP transistor Q31, a constant current V_{BEQ31}/R₃₁ passes through the resistor R31 with the resistance R₃₁, and this constant current is the emitter current I_{EQ32} of the PNP transistor Q32. When the base current of the PNP transistor Q32 is ignored, the LED module 3 is driven by this emitter current I_{EQ32}.

The pulsating voltage with a peak value of about 141 V described above is applied to a series circuit of the constant-current circuit B31, the LED module 3, and the thyristor 4; thus, let the forward voltage per LED be V_{F} and the number of stages of series connection in the LED module 3 be N, then, through the LED module 3, a current starts to pass when the peak value of the AC voltage outputted from the commercial power supply 1 of AC 100 V exceeds V_{F}×N, and no current passes when it is below V_{F}×N; accordingly the current that passes through the LED module 3 is a pulsating current, but the peak value of the current that passes through the LED module 3 does not exceed the value (V_{BEQ31}/R₃₁) set by the constant-current circuit B31. This makes it possible, even when the AC voltage outputted from the commercial power supply 1 of AC 100 V varies or when the number of stages of series connection in the LED module 3 is changed, to prevent a current equal to or larger than a predetermined current from passing through the LED module 3. Having the resistor R31 inserted between the base and emitter of the PNP transistor Q31, the constant-current circuit B31 has a negative temperature response (as temperature increases, the constant-current value decreases). Thus, in the LED drive circuit according to the invention shown in FIG. 3, even temperature increases, no current equal to or larger than a predetermined current passes through the LED module 3.

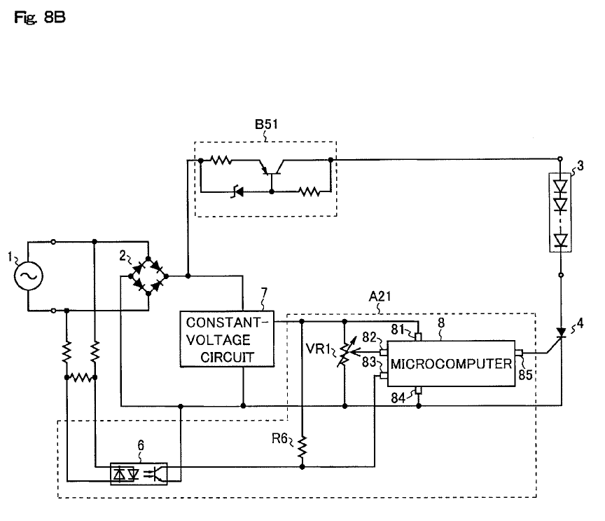

FIGS. 8A and 8B show embodiments where other constant-current circuits B41 and B51, respectively, configured with one transistor, one Zener diode, and two resistors, are used.

Note that in any of the embodiments described above, it is possible to replace the thyristor 4 with a triac, photothyristor, or phototriac. When the thyristor 4 is replaced with a photothyristor or phototriac, a light-emitting portion that outputs a light signal to control the photothyristor or phototriac is also provided. LED drive circuits according to the present invention are used, for example, in lighting apparatuses and electric display devices.

What is claimed is:

1. An LED drive circuit comprising:
a constant-current circuit supplying a constant current to an LED to drive the LED;
a thyristor, triac, photothyristor, or phototriac;
a phase-angle control circuit adjusting an ignition angle of the thyristor, triac, photothyristor, or phototriac,
wherein the LED, the constant-current circuit, and the thyristor, triac, photothyristor, or phototriac are connected in series.

2. The LED drive circuit according to claim 1,
wherein the constant-current circuit comprises solely of one or more transistors and resistors.

3. The LED drive circuit according to claim 1,
wherein the phase-angle control circuit has a capacitor and a resistor, and adjusts the ignition angle of the thyristor, triac, photothyristor, or phototriac to an angle corresponding to a time constant determined by a resistance of the resistor and a capacitance of the capacitor.

4. The LED drive circuit according to claim 1,
wherein, to a series-connection circuit of the LED, the constant-current circuit, and the thyristor, triac, photothyristor, or phototriac, a voltage based on an AC power supply voltage is applied, and
wherein the phase-angle control circuit detects a zero-cross point of the AC power supply voltage, and ignites the thyristor, triac, photothyristor, or phototriac a predetermined time after the zero-cross point of the AC power supply voltage, the predetermined time being variable.

5. The LED drive circuit according to claim 2,
wherein the transistor is a bipolar transistor.

6. The LED drive circuit according to claim 2,
wherein the phase-angle control circuit has a capacitor and a resistor, and adjusts the ignition angle of the thyristor, triac, photothyristor, or phototriac to an angle corresponding to a time constant determined by a resistance of the resistor and a capacitance of the capacitor.

7. The LED drive circuit according to claim 2,
wherein, to a series-connection circuit of the LED, the constant-current circuit, and the thyristor, triac, photothyristor, or phototriac, a voltage based on an AC power supply voltage is applied, and
wherein the phase-angle control circuit detects a zero-cross point of the AC power supply voltage, and ignites the thyristor, triac, photothyristor, or phototriac a predetermined time after the zero-cross point of the AC power supply voltage, the predetermined time being variable.

8. The LED drive circuit according to claim 5,
wherein the phase-angle control circuit has a capacitor and a resistor, adjusts an ignition angle of the thyristor, triac, photothyristor, or phototriac to an angle corresponding to a time constant determined by a resistance of the resistor and a capacitance of the capacitor.

9. The LED drive circuit according to claim 5,
wherein, to a series-connection circuit of the LED, the constant-current circuit, and the thyristor, triac, photothyristor, or phototriac, a voltage based on an AC power supply voltage is applied, and
wherein the phase-angle control circuit detects a zero-cross point of the AC power supply voltage, and ignites the thyristor, triac, photothyristor, or phototriac a predetermined time after the zero-cross point of the AC power supply voltage, the predetermined time being variable.
